(19) United States
(12) Patent Application Publication
(10) Pub. No.: US 2017/0116638 A1
(43) Pub. Date: Apr. 27, 2017

(54) A/B EXPERIMENT VALIDATION

(71) Applicant: Microsoft Technology Licensing, LLC, Redmond, WA (US)

(72) Inventors: Charles Clines, Bellevue, WA (US); Faisal Ilaiwi, Bellevue, WA (US); Alexander Viktorov, Bellevue, WA (US); Siddharth S. Shenoy, Sammamish, WA (US); Marcelo De Barros, Redmond, WA (US)

(21) Appl. No.: 14/921,717

(22) Filed: Oct. 23, 2015

(51) Int. Cl. G06Q 30/02

(52) U.S. Cl. CPC G06Q 30/0243

(57) ABSTRACT

A/B experiment validation implementations are presented that generally validate an A/B experiment prior to its release. One implementation involves employing multiple test execution engines to test a A/B experiment, and then aggregating the results. More particularly, a request to validate an A/B experiment is received from a requesting entity along with data pertaining to the A/B experiment. A category of the A/B experiment is then determined, and test execution engines applicable to the A/B experiment category are identified. For each test execution engine identified, the A/B experiment data is passed to the test execution engine, the test execution engine is requested to execute a test for the A/B experiment, and test results from the test of the A/B experiment are received. Once test results are received from the identified test execution engines, the test results are aggregated to produce a validation indicator.

### BACKGROUND

An A/B experiment compares two versions of an item, such as a webpage. Often, one of the versions is a current version or a base version (hereinafter referred to as a control version), while the other (hereinafter referred to as a modified version) exhibits a variation of an aspect of the control version. Alternately, both versions can be new with some aspect being different between them. In this latter scenario, an arbitrary one of the pair is considered the control version and the other acts as the modified version.

For instance, in the context of a webpage, the modified version could depict a selection button with a different size, or position, or color than the control version. Another example could be where the modified version exhibits a different layout or style. This latter example could include using more or less text, different fonts, different images or changing the size of an image on the webpage, among other things. Still further, the difference between the versions could involve the content of the webpage, such as a different description or a different heading.

An A/B experiment can involve presenting the control version to a first group of people and the modified version to a different group. In this case, the presentations of the different versions are usually done contemporaneously. Alternately, an A/B experiment can involve presenting the control version to a group of people and then the modified version to the same group. In either case, the experiment has criteria to determine if the modified version is better than the control version. To this end, the reactions the members of each group have to their assigned version are monitored. The particular reaction monitored is dependent on what aspect is different between the versions and is chosen to identify a person's interaction with that aspect. For example, with regard to the previously-described webpage button being different, the reaction monitored could be whether a person selected the button. The monitored reactions of people in the groups are used to determine which version is to be considered better. For instance, in the foregoing example, if more people selected the button in one of the versions, that version would be considered better.

### SUMMARY

The A/B experiment validation implementations described herein generally validate an A/B experiment prior to its release to the aforementioned groups of people. One or more computing devices are directed by program modules of an A/B experiment validation computer program to accomplish this task. More particularly, in one implementation, a request to validate an A/B experiment is received from a requesting entity along with data pertaining to the A/B experiment. A category of the A/B experiment is then determined, and one or more test execution engines applicable to the A/B experiment category are identified. For each test execution engine identified, the A/B experiment data is passed to the test execution engine via an interface component that is specific to this engine, the test execution engine is requested to execute a test for the A/B experiment also via the interface component that is specific to the engine, and test results from the test of the A/B experiment are received via the interface component specific to the test execution engine. Once test results are received from the identified test execution engine or engines, they are aggregated to produce a validation indicator.

Variations of the foregoing A/B experiment validation involve one implementation which contemporaneously validates a plurality of A/B experiments received from a requesting entity. In another implementation, an A/B experiment is validated in the manner described above except that the identification of test execution engines is handled using a test request broadcast.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more-detailed description that is presented below.

### DESCRIPTION OF THE DRAWINGS

The specific features, aspects, and advantages of the disclosure will become better understood with regard to the following description, appended claims, and accompanying drawings where:

FIG. 1 is a diagram illustrating one implementation, in simplified form, of a system framework used for validating an A/B experiment.

FIG. 2 is a flow diagram illustrating one implementation, in simplified form, of a process for validating an A/B experiment.

FIG. 3 is a diagram illustrating one implementation, in simplified form, of a system framework used for contemporaneously validating a plurality of A/B experiments received from a requesting entity.

FIGS. 4A-B are a flow diagram illustrating one implementation, in simplified form, of a process for contemporaneously validating a plurality of A/B experiments received from a requesting entity.

FIG. 5 is a diagram illustrating one implementation, in simplified form, of a system framework used for validating an A/B experiment which handles the identification of test execution engines using a test request broadcast.

FIGS. 6A-B are a flow diagram illustrating one implementation, in simplified form, of a process for validating an A/B experiment which handles the identification of test execution engines using a test request broadcast.

FIG. 7 is a diagram depicting a general purpose computing device constituting an exemplary system for use with the A/B experiment validation implementations described herein.

### DETAILED DESCRIPTION

In the following description reference is made to the accompanying drawings which form a part hereof, and in which are shown, by way of illustration, specific versions in which A/B experiment validation implementations can be practiced. It is understood that other implementations can be utilized and structural changes can be made without departing from the scope thereof.

It is also noted that for the sake of clarity specific terminology will be resorted to in describing the A/B experiment validation implementations and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation” means that a particular feature, a particular structure, or particular characteristics described in connection with the implementation can be included in at least one version of A/B experiment validation. The appearances of the phrases “in one implementation”, “in another implementation”, “in an exemplary implementation”, and “in an alternate implementation” in various places in the specification are not necessarily all referring to the same implementation, nor are separate or alternative implementations mutually exclusive of other implementations. Yet furthermore, the order of process flow representing one or more implementations of the project information extraction does not inherently indicate any particular order or imply any limitations thereof.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” and variants thereof, and other similar words are used in either this detailed description or the claims, these terms are intended to be inclusive in a manner similar to the term “comprising” as an open transition word without precluding any additional or other elements.

### 1.0 A/B Experiment Validation

It is evident for the foregoing description of an A/B experiment that a wide variety of these experiments having different goals, different reaction monitored, different winning criteria, and so on, are possible. As a result, prior to presenting an A/B experiment to the aforementioned groups of people, it is advantageous to first validate the operation of the experiment to insure it runs as intended. In the A/B experiment validation implementations described herein, this is accomplished by running various functional tests on an A/B experiment prior its release.

A test execution engine is generally a computer program that performs a functional test of an A/B experiment. More particularly, the test attempts to simulate how the experiment would operate when presented to the previously-described groups of people. If the test is successful in that it is determined the A/B experiment would operate as intended, then the test execution engine issues a pass indication. Otherwise, the test execution issues a fail indication.

Given the variety of A/B experiments possible, a multitude of test execution engines have been developed to test them. Generally, test execution engines are tailored to test a particular category of A/B experiments. Thus, a test execution engine inputs A/B experiment data for an A/B experiment of the category the engine is tailored to test. It can be easily imagined that even within the same category, some test execution engines may do a better job of testing a particular A/B experiment than others. The A/B experiment validation implementations described herein have an advantage in this regard. More particularly, the implementations described herein can employ multiple test execution engines to test the same A/B experiment, and then aggregate the results. Thus, when multiple test execution engines are available to test an A/B experiment, having at least some of these engines test the experiment and aggregating the results from each engine can produce a more reliable indication of whether the experiment would be successful. This then allows a user whose A/B experiment was found to be unsuccessful, to fix the problems before it is released to the aforementioned groups of people, thereby saving computing resources that would otherwise be wasted.

In general, the A/B experiment validation implementations described herein leverage existing test execution engines to execute tests on A/B experiments. A pluggable architecture is used which allows expansion into a virtually unlimited number of different text execution engines. The number of test execution engines to employ in the testing is determined based on availability and the category of the A/B experiment being validated. For example, if the A/B experiment is directed at a relatively simple user experience (UX) change, a subset of available test execution engines which are tailored to that category are run. These engines can be scheduled in parallel and the results for the engines are aggregated into a single value which indicates whether or not the experiment should be released.

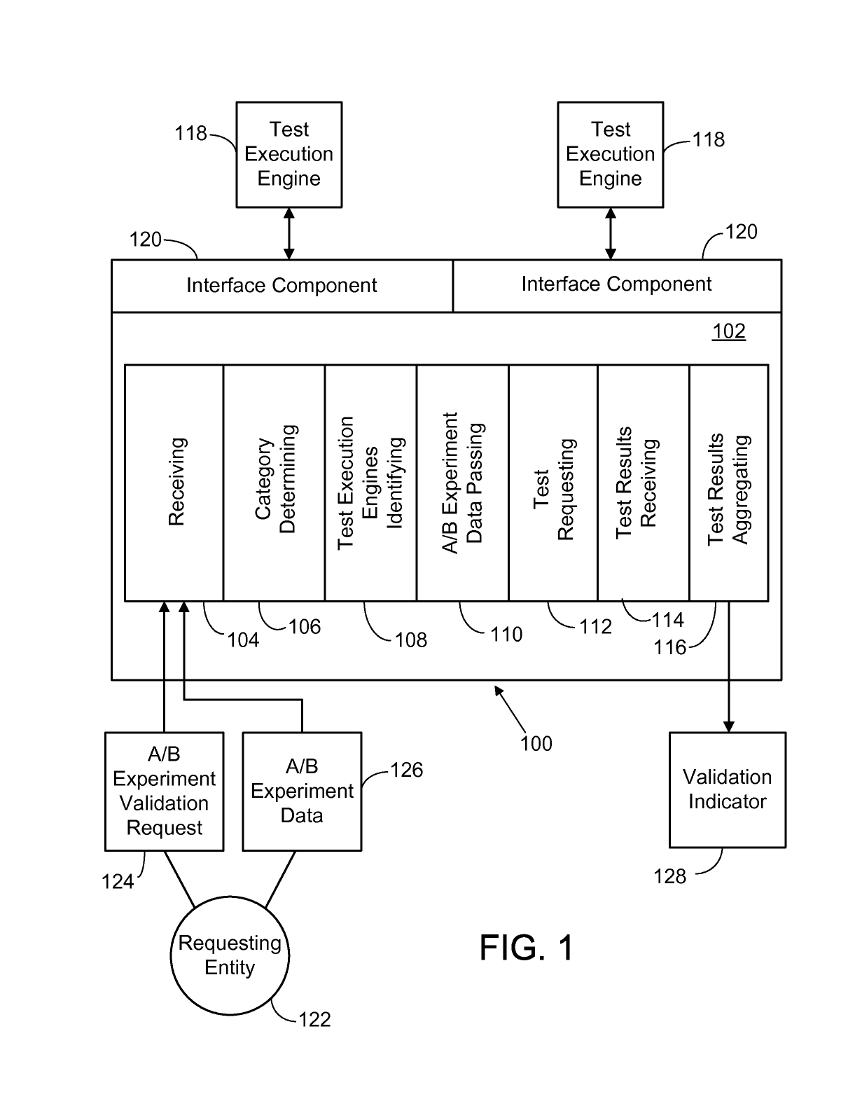

FIG. 1 illustrates an exemplary implementation, in simplified form, of a validation system framework used for validating an A/B experiment. As exemplified in FIG. 1, the validation system framework 100 includes a computer program 102 having program modules executable by one or more computing devices. These program modules include a receiving module 104, a category determining module 106, a test execution engines identifying module 108, an A/B experiment data passing module 110, a test requesting module 112, a test results receiving module 114, and a test results aggregating module 116. The A/B experiment data passing module 110, test requesting module 112 and a test results receiving module 114 are in communication with each of the test execution engines 118 identified by the test execution engines identifying module 108 via a separate interface component 120 specific to the test execution engine. It is noted that only two test execution engines 118 and associated interface components 120 are shown in FIG. 1. However, any number of engines 118 and associated interface components 120 can be employed. A request 124 to validate an A/B experiment from a requesting entity 122 along with data pertaining to the A/B experiment 126 are input to the receiving module 104, and a validation indicator 128 is output from the test results aggregating module 116. Each of these program modules is realized on one or more computing devices such as that described in more detail in the Exemplary Operating Environments section which follows. It is noted that whenever there is a plurality of computing devices they are in communication with each other via a computer network (such as the Internet or a proprietary intranet).

It is noted that in one implementation, the foregoing validation system framework is realized as a cloud service. The term “cloud service” is used herein to refer to a web application that operates in the cloud, and can be hosted on (e.g., deployed at) a plurality of data centers that can be located in different geographic regions (e.g., different regions of the world), and can be concurrently used by a plurality of remote end users. To this end, although the system framework 100 depicts a single requesting entity 122, yet another system framework implementation (not shown) is also possible where the cloud service is provided simultaneously to a plurality of requesting entities.

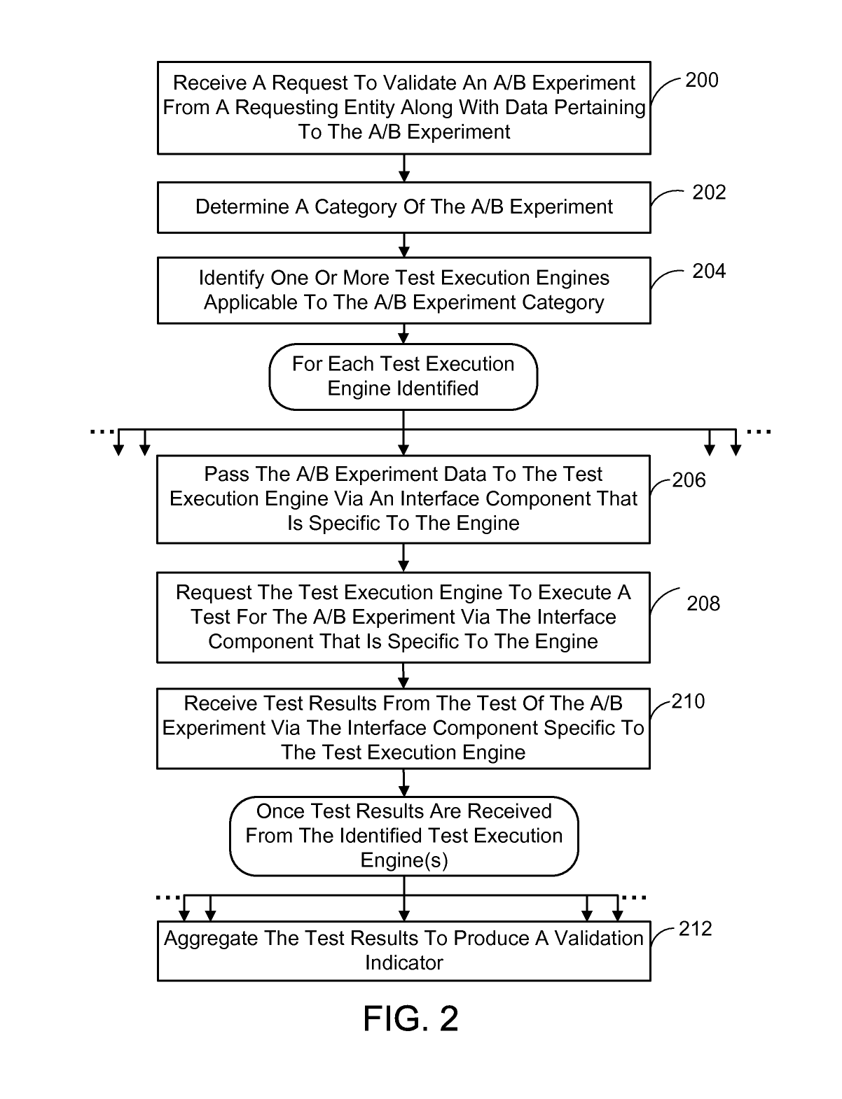

Referring now to FIG. 2, the aforementioned one or more computing devices are directed by the foregoing program modules of the computer program to accomplish a series of process actions. More particularly, a request to validate an A/B experiment is received from a requesting entity along with data pertaining to the A/B experiment (process action 200). A category of the A/B experiment is then determined (process action 202). Next, one or more test execution engines applicable to the A/B experiment category are identified (process action 204). For each test execution engine identified, the A/B experiment data is passed to the test execution engine via an interface component that is specific to the engine (process action 206), the test execution engine is requested to execute a test for the A/B experiment also via the interface component that is specific to the engine (process action 208), and test results from the test of the A/B experiment are received via the interface component specific to the test execution engine (process action 210). Once test results are received from the identified test execution engine or engines, the test results are aggregated to produce a validation indicator (process action 212). The foregoing actions will be described in more detail in the sections to follow.

### 1.1 Receiving A Validation Request

With regard to receiving a request to validate an A/B experiment along with data pertaining to the A/B experiment, as indicated previously the request and data comes from a requesting entity usually via a computer network such as the Internet or a proprietary intranet. In one implementation, the experiment data includes a control version of an item being validated, a modified version of the item, the reaction being monitored, and winning criteria for an aspect of the item being compared between the two versions. However, depending on the A/B experiment, other data items could also be included, such as the name of the experiment, supporting data associated with the test, initial conditions, a set of triggering events, a test sequence, and so on.

### 1.2 Determining The Category Of An A/B Experiment

With regard to determining the category of the A/B experiment, in one implementation the level of the “stack” that the experiment targets is identified. For example, but without limitation, A/B categories can include user experience (UX), data, backend, performance, monitoring, and so on.

### 1.3 Identifying Test Execution Engines

With regard to identifying a test execution engine or engines applicable to the A/B experiment's determined category, in one implementation this involves selecting test execution engine(s) from a list of available engines. In one version, this list is populated with registered test execution engines. A registered test execution engine is one that has agreed to run A/B experiments provided by the validation system, and one that has provided a set of capabilities including the category of A/B experiment the test execution engine is capable of running. As such, the selection process involves selecting a test execution engine or engines whose capabilities match the A/B experiment being validated.

### 1.4 Passing The A/B Experiment Data To A Test Execution Engine

With regard to passing A/B experiment data to a test execution engine via an interface component that is specific to the engine, in one implementation this includes providing parameters and information that the engine needs to run a test tailored to the A/B experiment. In one version, the particular parameters and information needed are specified by the test execution engine in the aforementioned set of capabilities provided by the test execution engine when registering with the validation system.

With regard to the interface component, in general this is a plug-in associated with the validation system that knows how to interact directly with the test execution engine it is targeting. Thus, each interface component is specific to a particular test execution engine. It is the interface component that converts the aforementioned A/B experiment data into a job that the text execution engine understands.

### 1.5 Requesting The Test Execution Engine To Test An A/B Experiment

With regard to requesting the test execution engine to execute a test for the A/B experiment via the interface component that is specific to the engine, in one implementation where more than one identified test execution engine is requested to run the A/B experiment test, the tests are requested substantially simultaneously so that they are run in parallel by the identified test execution engines. In this way, the test results from the various test execution engines are received somewhat together.

### 1.6 Receiving The Test Results

With regard to receiving test results from the test of an A/B experiment via the interface component specific to the test execution engine, in one implementation after the test execution engine or engines are requested to execute a test for the A/B experiment, each engine is periodically polled for the test results.

As described previously, if the test is successful in that it is determined the A/B experiment would operate as intended, then the test execution engine issues a pass indication. Otherwise, the test execution engine issues a fail indication. The indication produced by some test execution engines is simply a pass or a fail. However, in other test execution engines, the indication issued is a score or probability value, which is a number indicating the likelihood that the A/B experiment would operate as intended.

### 1.7 Aggregating The Test Results

With regard to aggregating the test results received from the test execution engines to produce a validation indicator, in the case where there is only one test execution engine involved, the test result received from that engine is designated as the validation indicator.

In cases where more than one identified test execution engine is requested to run an A/B experiment test, and the test results received from the test execution engines are each in the form of a pass or a fail, several possibilities exist for aggregating the test results to produce a validation indicator. In one implementation, a validated A/B experiment is indicated if all the test results received from the identified test execution engines indicate a success. If even one engine reports a fail, the validation indicator generated from the aggregated test results indicates that the A/B experiment failed validation. In another implementation, a validated A/B experiment is indicated if a majority of the test results received from the identified test execution engines are a pass. In yet another implementation, a validated A/B experiment is indicated if a prescribed percentage or more of the test results received from the identified test execution engines are a pass.

In cases where more than one identified test execution engine is requested to run an A/B experiment test, and the test results received from the test execution engines are each in the form of a probability value indicative of the probability the A/B experiment will be successful, several possibilities also exist for aggregating the test results to produce a validation indicator. In one implementation, a validated A/B experiment is indicated if the average of the probability values exceeds a prescribed success threshold value. In another implementation, a weighted average of the probability values is calculated based on prescribed weights which favor (i.e., higher weight) some test execution engines over others. In one version of the weighted average calculation, the weights are based on the number of tests executed by a test execution engine, with a higher weight being assigned to a more experienced engine. In yet another implementation, the probability values are AND-ed together.

### 1.8 Providing The Validation Indicator

With regard to providing the validation indicator, in one implementation it is provided to the requesting entity. In addition, one version of this implementation involves, whenever the validation indicator indicates a validated A/B experiment, allowing the A/B experiment to be presented to groups of people for evaluation.

### 1.9 Contemporaneous Validation Of Multiple A/B Exeriments

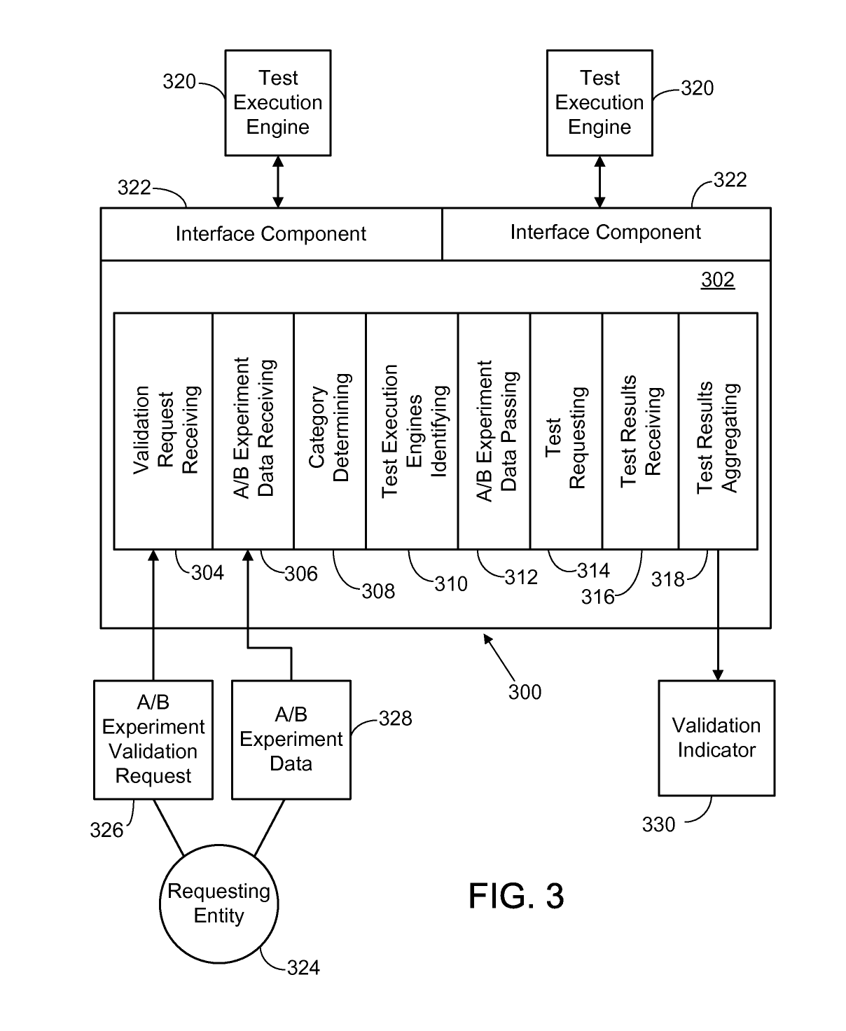

FIG. 3 illustrates an exemplary implementation, in simplified form, of a validation system framework used for contemporaneously validating a plurality of A/B experiments received from a requesting entity. As exemplified in FIG. 3, the validation system framework 300 includes a computer program 302 having program modules executable by one or more computing devices. These program modules include a validation request receiving module 304, a A/B experiment data receiving module 306, a category determining module 308, a test execution engines identification module 310, an A/B experiment data passing module 312, a test requesting module 314, a test results receiving module 316, and a test results aggregating module 318. The A/B experiment data passing module 312, test requesting module 314 and a test results receiving module 316 are in communication with each of the test execution engines 320 identified by the test execution engines identifying module 310 via a separate interface component 322 specific to the test execution engine. It is noted that only two test execution engines 320 and associated interface components 322 are shown in FIG. 3. However, any number of engines 320 and associated interface components 322 can be employed. A request 326 to validate a group of A/B experiments from a requesting entity 324 are input to the receiving module 304, data pertaining to each A/B experiment 328 is input to the A/B experiment data receiving module 306, and a validation indicator 330 for each A/B experiment is output from the test results aggregating module 318. Each of these program modules is realized on one or more computing devices such as that described in more detail in the Exemplary Operating Environments section which follows. It is noted that whenever there is a plurality of computing devices they are in communication with each other via a computer network (such as the Internet or a proprietary intranet). The foregoing validation system framework used for contemporaneously validating a plurality of A/B experiments can also be realized as a cloud service.

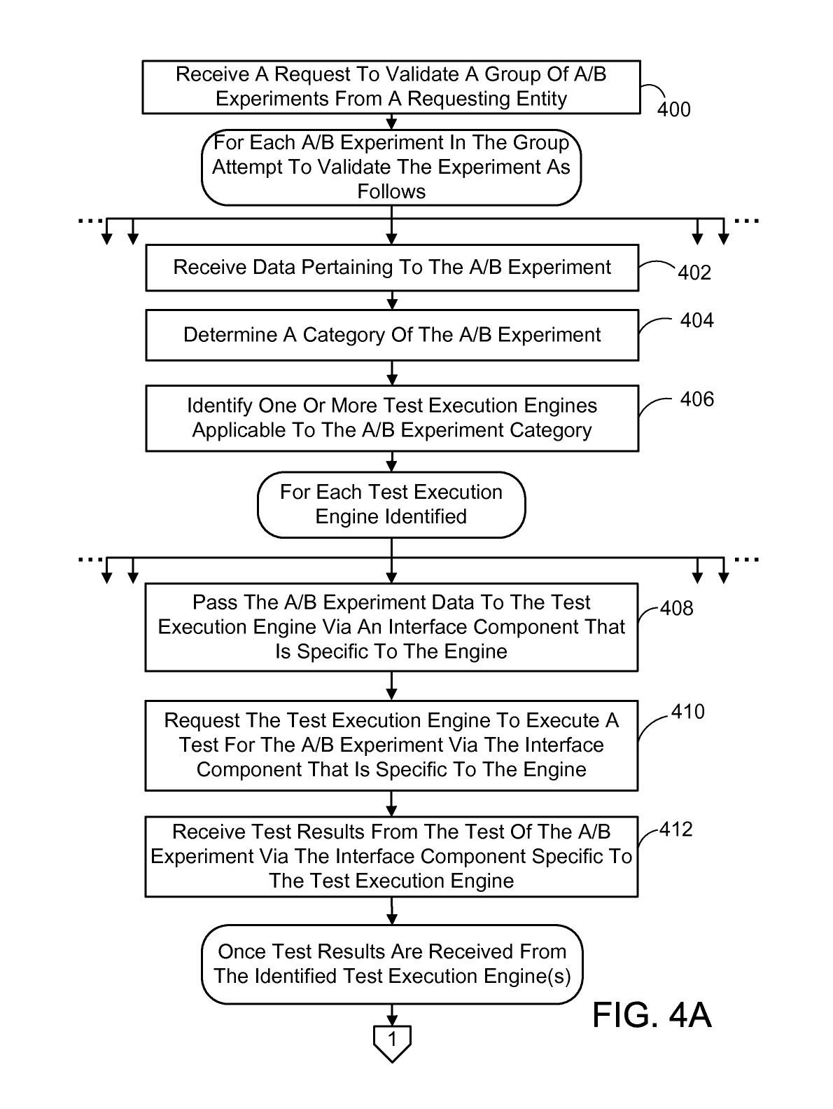

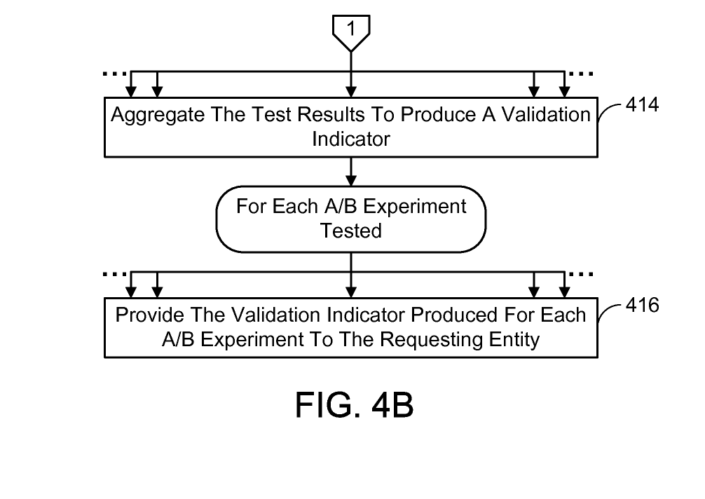

Referring now to FIGS. 4A-B, the aforementioned one or more computing devices are directed by the foregoing program modules of the computer program to accomplish a series of process actions. More particularly, a request to validate a group of A/B experiments is received from a requesting entity (process action 400). For each A/B experiment in the group, the following process actions are performed in an attempt to validate the experiment (one of which is shown in FIG. 4). Data pertaining to the A/B experiment is received (process action 402), and a category of the A/B experiment is determined (process action 404). Next, one or more test execution engines applicable to the A/B experiment category are identified (process action 406). For each test execution engine identified, the A/B experiment data is passed to the test execution engine via an interface component that is specific to the engine (process action 408), the test execution engine is requested to execute a test for the A/B experiment also via the interface component that is specific to the engine (process action 410), and test results from the test of the A/B experiment are received via the interface component specific to the test execution engine (process action 412). Once test results are received from the identified test execution engine or engines, the test results are aggregated to produce a validation indicator for the A/B experiment (process action 414). In one implementation (which is shown in FIG. 4B), the validation indicator produced for each A/B experiment tested is provided to the requesting entity (process action 416).

In one implementation of the foregoing, the validation of each A/B experiment is performed in parallel. In addition, in one implementation, for each A/B experiment tested by more than one identified test execution engine, the tests are run in parallel by these engines.

### 1.10 Test Request Broadcasting

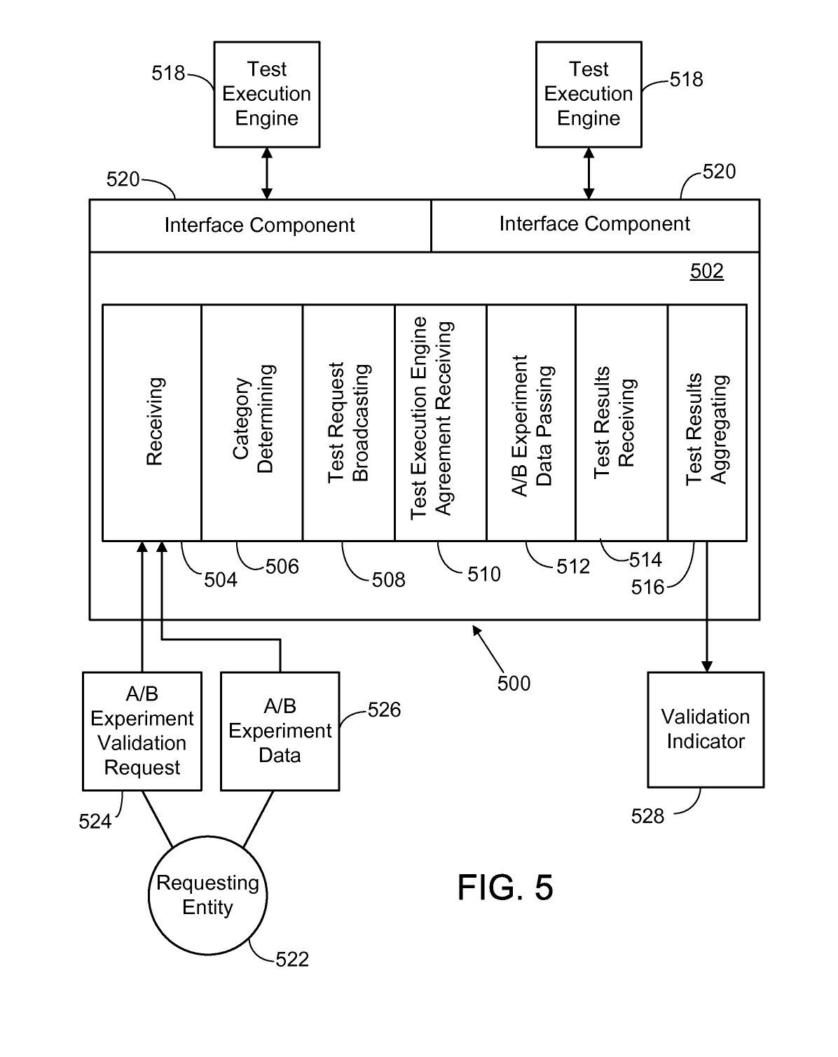

FIG. 5 illustrates an exemplary implementation, in simplified form, of a validation system framework used for validating an A/B experiment which handles the identification of test execution engines in a different way from that described previously—namely using a test request broadcast scenario. As exemplified in FIG. 5, the validation system framework 500 includes a computer program 502 having program modules executable by one or more computing devices. These program modules include a receiving module 504, a category determining module 506, a test request broadcasting module 508, a test execution engine agreement receiving module 510, an A/B experiment data passing module 512, a test results receiving module 514, and a test results aggregating module 516. The A/B experiment data passing module 512 and test results receiving module 514 are in communication with the test execution engines 518 who have agreed to test the A/B experiment via a separate interface component 520 specific to each test execution engine. It is noted that only two test execution engines 518 and associated interface components 520 are shown in FIG. 5. However, any number of engines 518 and associated interface components 520 can be employed. A request 524 to validate an A/B experiment from a requesting entity 522 along with data pertaining to the A/B experiment 526 are input to the receiving module 504, and a validation indicator 528 is output from the test results aggregating module 516. Each of these program modules is realized on one or more computing devices such as that described in more detail in the Exemplary Operating Environments section which follows. It is noted that whenever there is a plurality of computing devices they are in communication with each other via a computer network (such as the Internet or a proprietary intranet). The foregoing validation system framework employing a test request broadcast can also be realized as a cloud service.

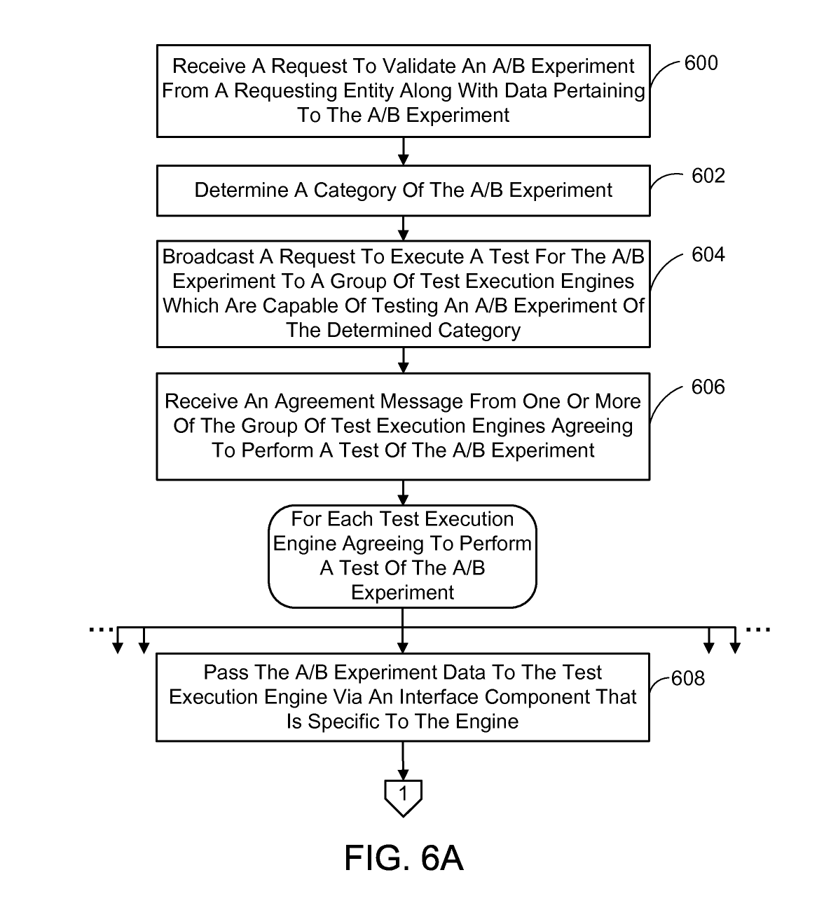

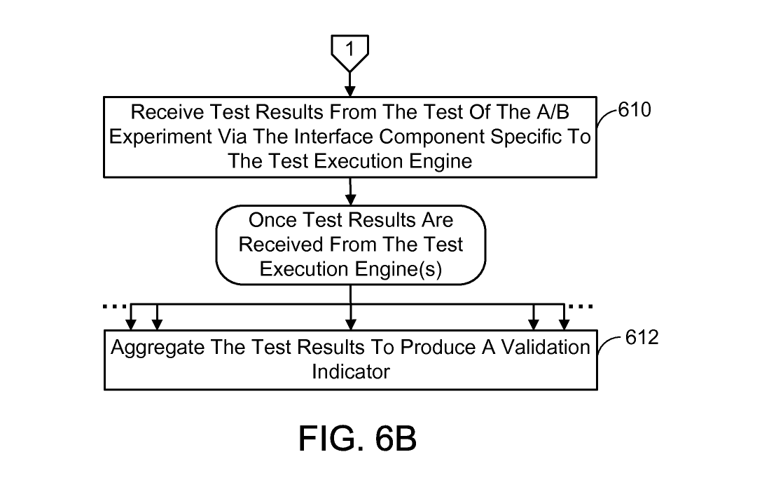

Referring now to FIGS. 6A-B, the aforementioned one or more computing devices are directed by the foregoing program modules of the computer program to accomplish a series of process actions. More particularly, a request to validate an A/B experiment is received from a requesting entity along with data pertaining to the A/B experiment (process action 600). A category of the A/B experiment is then determined (process action 602). Next, a request to execute a test for the A/B experiment is broadcast to a group of test execution engines which are capable of testing an A/B experiment of the determined category (process action 604), and an agreement message is received from one or more of this group of test execution engines agreeing to perform a test of the A/B experiment (process action 606). For each test execution engine agreeing to perform a test of the A/B experiment, the A/B experiment data is passed to the test execution engine via an interface component that is specific to the engine (process action 608), and test results from the test of the A/B experiment are received via the interface component specific to the test execution engine (process action 610). Once test results are received from the test execution engine or engines, the test results are aggregated to produce a validation indicator (process action 612).

### 2.0 Exemplary Operating Environments

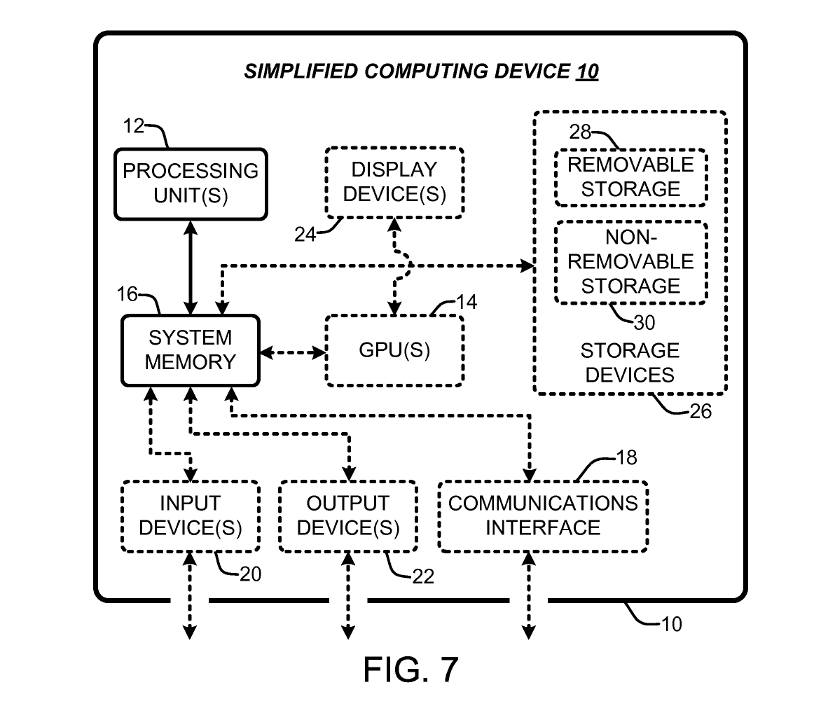

The A/B experiment validation implementations described herein are operational using numerous types of general purpose or special purpose computing system environments or configurations. FIG. 7 illustrates a simplified example of a general-purpose computer system with which various aspects and elements of A/B experiment validation, as described herein, may be implemented. It is noted that any boxes that are represented by broken or dashed lines in the simplified computing device 10 shown in FIG. 7 represent alternate implementations of the simplified computing device. As described below, any or all of these alternate implementations may be used in combination with other alternate implementations that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To realize the A/B experiment validation implementations described herein, the device should have a sufficient computational capability and system memory to enable basic computational operations. In particular, the computational capability of the simplified computing device 10 shown in FIG. 7 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 10 may also include other components, such as, for example, a communications interface 18. The simplified computing device 10 may also include one or more conventional computer input devices 20 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 10 and with any other component or feature of wearable sensing, including input, output, control, feedback, and response to one or more users or other devices or systems associated with A/B experiment validation, are enabled by a variety of Natural User Interface (NUI) scenarios. The NUI techniques and scenarios enabled by A/B experiment validation include, but are not limited to, interface technologies that allow one or more users user to interact in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other sensors. Such NUI implementations are also enabled by the use of various techniques including, but not limited to, information derived from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the A/B experiment validation implementations described herein.

However, it should be understood that the aforementioned exemplary NUI scenarios may be further augmented by combining the use of artificial constraints or additional signals with any combination of NUI inputs. Such artificial constraints or additional signals may be imposed or generated by input devices such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the A/B experiment validation implementations described herein.

The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 7 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, program modules, or other data. Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various A/B experiment validation implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The A/B experiment validation implementations described herein may be further described in the general context of computer-executable instructions, such as program modules, being executed by a computing device. Generally, program modules include routines, programs, objects, components, data structures, and the like, that perform particular tasks or implement particular abstract data types. The A/B experiment validation implementations described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), and so on.

### 3.0 Other Implementations

It is noted that any or all of the aforementioned implementations throughout the description may be used in any combination desired to form additional hybrid implementations. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

### 4.0 Claim Support And Further Implementations

The following paragraphs summarize various examples of implementations which may be claimed in the present document. However, it should be understood that the implementations summarized below are not intended to limit the subject matter which may be claimed in view of the foregoing descriptions. Further, any or all of the implementations summarized below may be claimed in any desired combination with some or all of the implementations described throughout the foregoing description and any implementations illustrated in one or more of the figures, and any other implementations described below. In addition, it should be noted that the following implementations are intended to be understood in view of the foregoing description and figures described throughout this document.

In one implementation, a system is employed for validating an A/B experiment. This system includes one or more computing devices, the computing devices being in communication with each other via a computer network whenever there is a plurality of computing devices. The system also includes a computer program having program modules executable by the one or more computing devices. The one or more computing devices are directed by the program modules of the computer program to receive a request to validate an A/B experiment from a requesting entity along with data pertaining to the A/B experiment, determine a category of the A/B experiment, identify one or more test execution engines applicable to the A/B experiment category, and for each test execution engine identified, pass the A/B experiment data to the test execution engine via an interface component that is specific to the engine, request the test execution engine to execute a test for the A/B experiment, and receive via the interface component specific to the test execution engine, test results from the test of the A/B experiment. Once test results are received from the identified test execution engine or engines, they are aggregated to produce a validation indicator.

In one implementation of the system, the A/B experiment data includes a control version of an item, a modified version of the item, a reaction being monitored, and winning criteria for an aspect of the item being compared between the two versions. In addition, in one implementation, the A/B experiment categories include user experience (UX), data, backend, performance and monitoring.

In one implementation of the system, the program module for identifying one or more test execution engines applicable to the A/B experiment category, includes selecting the one or more test execution engines from a list of available test execution engines. In one version of this implementation where a registered test execution engine is one that has agreed to run A/B experiments and has provided a set of capabilities comprising the category of A/B experiment the test execution engine is capable of running, the program module for selecting the one or more test execution engines from a list of available test execution engines includes selecting a registered test execution engine whose capabilities match the A/B experiment being validated.

In one implementation of the system, the program module for passing the A/B experiment data to the test execution engine via an interface component that is specific to the engine, includes parameters and information identified by the test execution engine that the engine needs to run a test tailored to the A/B experiment. In addition, in one implementation of the system where more than one identified test execution engine is requested to run an A/B experiment test, the tests run by the identified test execution engines are run in parallel. Still further, in one implementation the system includes a program module, executed after requesting the test execution engine to execute a test for the A/B experiment, for periodically polling the test execution engine for test results.

In one implementation of the system where more than one identified test execution engine is requested to run an A/B experiment test, and the test results received from the identified test execution engines are each in the form of a pass or a fail, the program module for aggregating the test results to produce a validation indicator, includes indicating a failure of the A/B experiment if one or more of the test results received from the identified test execution engines is a fail. In another implementation of the system where more than one identified test execution engine is requested to run an A/B experiment test, and the test results received from the identified test execution engines are each in the form of a pass or a fail, the program module for aggregating the test results to produce a validation indicator, includes indicating a validated A/B experiment if a majority of the test results received from the identified test execution engines are a pass. And in yet another implementation of the system where more than one identified test execution engine is requested to run an A/B experiment test, and the test results received from the identified test execution engines are each in the form of a pass or a fail, the program module for aggregating the test results to produce a validation indicator, includes indicating a validated A/B experiment if a prescribed percentage or more of the test results received from the identified test execution engines are a pass.

In one implementation of the system where more than one identified test execution engine is requested to run an A/B experiment test, and the test results received from the identified test execution engines are each in the form of a probability value indicative of the probability the A/B experiment will be successful, the program module for aggregating the test results to produce a validation indicator, includes indicating a validated A/B experiment if the average of the probability values exceeds a prescribed success threshold value. In another implementation of the system where more than one identified test execution engine is requested to run an A/B experiment test, and the test results received from the identified test execution engines are each in the form of a probability value indicative of the probability the A/B experiment will be successful, the program module for aggregating the test results to produce a validation indicator, includes computing a weighted average of the probability values wherein each of the identified test execution engines is assigned a prescribed weight, and indicating a validated A/B experiment if the weighted average of the probability values exceeds a prescribed success threshold value. In yet another implementation of the system where more than one identified test execution engine is requested to run an A/B experiment test, and the test results received from the identified test execution engines are each in the form of a probability value indicative of the probability the A/B experiment will be successful, the program module for aggregating the test results to produce a validation indicator, includes AND-ing together the probability values, and indicating a validated A/B experiment if the resulting value exceeds a prescribed success threshold value.

One implementation of the system further includes a program module for providing the validation indicator to the requesting entity. In addition, one implementation of the system further includes a program module for, whenever the validation indicator indicates a validated A/B experiment, allowing the A/B experiment to be presented to groups of people for evaluation.

In one implementation, a system is employed for contemporaneously validating a plurality of A/B experiments. This system includes one or more computing devices, the computing devices being in communication with each other via a computer network whenever there is a plurality of computing devices. The system also includes a computer program having program modules executable by the one or more computing devices. The one or more computing devices are directed by the program modules of the computer program to receive a request to validate a group of A/B experiments from a requesting entity, and for each A/B experiment, receive data pertaining to the A/B experiment, determine a category of the A/B experiment, identify one or more test execution engines applicable to the A/B experiment category, and for each test execution engine identified, pass the A/B experiment data to the test execution engine via an interface component that is specific to the engine, request the test execution engine to execute a test for the A/B experiment, and receive via the interface component specific to the test execution engine, test results from the test of the A/B experiment. Once test results are received from the identified test execution engine or engines, they are aggregated to produce a validation indicator for the A/B experiment.

One implementation of the system further includes a program module for providing the validation indicator for each A/B experiment tested to the requesting entity. In addition, in one implementation of the system, the validation of each A/B experiment is performed in parallel.

In one implementation, a system is employed for validating an A/B experiment. This system includes one or more computing devices, the computing devices being in communication with each other via a computer network whenever there is a plurality of computing devices. The system also includes a computer program having program modules executable by the one or more computing devices. The one or more computing devices are directed by the program modules of the computer program to receive a request to validate an A/B experiment from a requesting entity along with data pertaining to the A/B experiment, determine a category of the A/B experiment, broadcast a request to execute a test for the A/B experiment to a group of test execution engines which are capable of testing an A/B experiment of the category determined for the A/B experiment being validated, receive an agreement message from one or more of said group of test execution engines agreeing to perform the test of the A/B experiment, and for each test execution engine agreeing to perform a test of the A/B experiment, pass the A/B experiment data to the test execution engine via an interface component that is specific to the engine, and receive via the interface component specific to the test execution engine, test results from the test of the A/B experiment. Once test results are received from the identified test execution engine or engines, they are aggregated to produce a validation indicator.

In one implementation, a computer-implemented process is employed for validating an A/B experiment, which includes using a computing device to perform the following process actions: receiving a request to validate an A/B experiment from a requesting entity along with data pertaining to the A/B experiment; determining a category of the A/B experiment; identifying one or more test execution engines applicable to the A/B experiment category; and for each test execution engine identified, passing the A/B experiment data to the test execution engine via an interface component that is specific to the engine, requesting the test execution engine to execute a test for the A/B experiment, and receiving via the interface component specific to the test execution engine, test results from the test of the A/B experiment. Once test results are received from the identified test execution engine or engines, they are aggregated to produce a validation indicator.

In one implementation, a computer-implemented process is employed for contemporaneously validating a plurality of A/B experiments, which includes using a computing device to perform the following process actions: receiving a request to validate a group of A/B experiments from a requesting entity; and for each A/B experiment, receiving data pertaining to the A/B experiment, determining a category of the A/B experiment, identifying one or more test execution engines applicable to the A/B experiment category, and for each test execution engine identified, passing the A/B experiment data to the test execution engine via an interface component that is specific to the engine, requesting the test execution engine to execute a test for the A/B experiment, and receiving via the interface component specific to the test execution engine, test results from the test of the A/B experiment. Once test results are received from the identified test execution engine or engines, they are aggregated to produce a validation indicator for the A/B experiment.

In one implementation, a computer-implemented process is employed for validating an A/B experiment, which includes using a computing device to perform the following process actions: receiving a request to validate an A/B experiment from a requesting entity along with data pertaining to the A/B experiment; determining a category of the A/B experiment; broadcasting a request to execute a test for the A/B experiment to a group of test execution engines which are capable of testing an A/B experiment of the category determined for the A/B experiment being validated; receiving an agreement message from one or more of said group of test execution engines agreeing to perform the test of the A/B experiment; and for each test execution engine agreeing to perform a test of the A/B experiment, passing the A/B experiment data to the test execution engine via an interface component that is specific to the engine, and receiving via the interface component specific to the test execution engine, test results from the test of the A/B experiment. Once test results are received from the identified test execution engine or engines, they are aggregated to produce a validation indicator.

In one implementation, validating an A/B experiment includes using a computing device to perform the following process steps: a receiving step for receiving a request to validate an A/B experiment from a requesting entity along with data pertaining to the A/B experiment; a determining step for determining a category of the A/B experiment; an identifying step for identifying one or more test execution engines applicable to the A/B experiment category; and for each test execution engine identified, a passing step for passing the A/B experiment data to the test execution engine via an interface component that is specific to the engine, a requesting step for requesting the test execution engine to execute a test for the A/B experiment, and a second receiving step for receiving via the interface component specific to the test execution engine, test results from the test of the A/B experiment. Once test results are received from the identified test execution engine or engines, they are aggregated in an aggregating step to produce a validation indicator.

In one implementation, contemporaneously validating a plurality of A/B experiments includes using a computing device to perform the following process steps: a receiving step for receiving a request to validate a group of A/B experiments from a requesting entity; and for each A/B experiment, a second receiving step for receiving data pertaining to the A/B experiment, a determining step for determining a category of the A/B experiment, an identifying step for identifying one or more test execution engines applicable to the A/B experiment category, and for each test execution engine identified, a passing step for passing the A/B experiment data to the test execution engine via an interface component that is specific to the engine, a requesting step for requesting the test execution engine to execute a test for the A/B experiment, and a third receiving step for receiving via the interface component specific to the test execution engine, test results from the test of the A/B experiment. Once test results are received from the identified test execution engine or engines, they are aggregated in an aggregating step to produce a validation indicator for the A/B experiment.

In one implementation, validating an A/B experiment includes using a computing device to perform the following process steps: a receiving step for receiving a request to validate an A/B experiment from a requesting entity along with data pertaining to the A/B experiment; a determining step for determining a category of the A/B experiment; a broadcasting step for broadcasting a request to execute a test for the A/B experiment to a group of test execution engines which are capable of testing an A/B experiment of the category determined for the A/B experiment being validated; a second receiving step for receiving an agreement message from one or more of said group of test execution engines agreeing to perform the test of the A/B experiment; and for each test execution engine agreeing to perform a test of the A/B experiment, a passing step for passing the A/B experiment data to the test execution engine via an interface component that is specific to the engine, and a third receiving step for receiving via the interface component specific to the test execution engine, test results from the test of the A/B experiment. Once test results are received from the identified test execution engine or engines, they are aggregated in an aggregating step to produce a validation indicator.

Wherefore, what is claimed is:

1. A system for validating an A/B experiment, comprising:
one or more computing devices, said computing devices being in communication with each other via a computer network whenever there is a plurality of computing devices; and
a computer program having program modules executable by the one or more computing devices, the one or more computing devices being directed by the program modules of the computer program to,
receive a request to validate an A/B experiment from a requesting entity along with data pertaining to the A/B experiment,
determine a category of the A/B experiment,
identify one or more test execution engines applicable to the A/B experiment category,
for each test execution engine identified,
pass the A/B experiment data to the test execution engine via an interface component that is specific to the engine,
request the test execution engine to execute a test for the A/B experiment, and
receive via the interface component specific to the test execution engine, test results from the test of the A/B experiment, and
once test results are received from the identified test execution engine or engines, aggregate the test results to produce a validation indicator.

2. The system of claim 1, wherein said A/B experiment data comprises a control version of an item, a modified version of the item, a reaction being monitored, and winning criteria for an aspect of the item being compared between the two versions.

3. The system of claim 1, wherein said A/B experiment categories comprise user experience (UX), data, backend, performance and monitoring.

4. The system of claim 1, wherein the program module for identifying one or more test execution engines applicable to the A/B experiment category, comprises selecting the one or more test execution engines from a list of available test execution engines.

5. The system of claim 4, wherein a registered test execution engine is one that has agreed to run A/B experiments and has provided a set of capabilities comprising the category of A/B experiment the test execution engine is capable of running, and wherein the program module for selecting the one or more test execution engines from a list of available test execution engines comprises selecting a registered test execution engine whose capabilities match the A/B experiment being validated.

6. The system of claim 1, wherein the program module for passing the A/B experiment data to the test execution engine via an interface component that is specific to the engine, comprises providing parameters and information identified by the test execution engine that the engine needs to run a test tailored to the A/B experiment.

7. The system of claim 1, wherein more than one identified test execution engine is requested to run an A/B experiment test, and wherein the tests run by the identified test execution engines are run in parallel.

8. The system of claim 1, further comprising a program module, executed after requesting the test execution engine to execute a test for the A/B experiment, for periodically polling the test execution engine for test results.

9. The system of claim 1, wherein more than one identified test execution engine is requested to run an A/B experiment test, and the test results received from the identified test execution engines are each in the form of a pass or a fail, and wherein the program module for aggregating the test results to produce a validation indicator, comprises indicating a failure of the A/B experiment if one or more of the test results received from the identified test execution engines is a fail.

10. The system of claim 1, wherein more than one identified test execution engine is requested to run an A/B experiment test, and the test results received from the identified test execution engines are each in the form of a pass or a fail, and wherein the program module for aggregating the test results into a validation indicator, comprises indicating a validated A/B experiment if a majority of the test results received from the identified test execution engines are a pass.

11. The system of claim 1, wherein more than one identified test execution engine is requested to run an A/B experiment test, and the test results received from the identified test execution engines are each in the form of a pass or a fail, and wherein the program module for aggregating the test results to produce a validation indicator, comprises indicating a validated A/B experiment if a prescribed percentage or more of the test results received from the identified test execution engines are a pass.

12. The system of claim 1, wherein more than one identified test execution engine is requested to run an A/B experiment test, and the test results received from the identified test execution engines are each in the form of a probability value indicative of the probability the A/B experiment will be successful, and wherein the program module for aggregating the test results to produce a validation indicator, comprises indicating a validated A/B experiment if the average of the probability values exceeds a prescribed success threshold value.

13. The system of claim 1, wherein more than one identified test execution engine is requested to run an A/B experiment test, and the test results received from the identified test execution engines are each in the form of a probability value indicative of the probability the A/B experiment will be successful, and wherein the program module for aggregating the test results to produce a validation indicator, comprises computing a weighted average of the probability values wherein each of the identified test execution engines is assigned a prescribed weight, and indicating a validated A/B experiment if the weighted average of the probability values exceeds a prescribed success threshold value.

14. The system of claim 1, wherein more than one identified test execution engine is requested to run an A/B experiment test, and the test results received from the identified test execution engines are each in the form of a probability value indicative of the probability the A/B experiment will be successful, and wherein the program module for aggregating the test results to produce a validation indicator, comprises AND-ing together the probability values, and indicating a validated A/B experiment if the resulting value exceeds a prescribed success threshold value.

15. The system of claim 1, further comprising a program module for providing the validation indicator to the requesting entity.

16. The system of claim 1, further comprising a program module for, whenever the validation indicator indicates a validated A/B experiment, allowing the A/B experiment to be presented to groups of people for evaluation.

17. A system for contemporaneously validating a plurality of A/B experiments, comprising:
one or more computing devices, said computing devices being in communication with each other via a computer network whenever there is a plurality of computing devices; and
a computer program having program modules executable by the one or more computing devices, the one or more computing devices being directed by the program modules of the computer program to,
receive a request to validate a group of A/B experiments from a requesting entity,
for each A/B experiment,
receive data pertaining to the A/B experiment,
determine a category of the A/B experiment,
identify one or more test execution engines applicable to the A/B experiment category,
for each test execution engine identified,
pass the A/B experiment data to the test execution engine via an interface component that is specific to the engine,
request the test execution engine to execute a test for the A/B experiment, and
receive via the interface component specific to the test execution engine, test results from the test of the A/B experiment, and
once test results are received from the identified test execution engine or engines, aggregate the test results to produce a validation indicator for the A/B experiment.

18. The system of claim 17, further comprising a program module for providing the validation indicator for each A/B experiment tested to the requesting entity.

19. The system of claim 17, wherein the validation of each A/B experiment is performed in parallel.

20. A system for validating an A/B experiment, comprising:
one or more computing devices, said computing devices being in communication with each other via a computer network whenever there is a plurality of computing devices; and
a computer program having program modules executable by the one or more computing devices, the one or more computing devices being directed by the program modules of the computer program to,
receive a request to validate an A/B experiment from a requesting entity along with data pertaining to the A/B experiment,
determine a category of the A/B experiment,
broadcast a request to execute a test for the A/B experiment to a group of test execution engines which are capable of testing an A/B experiment of the category determined for the A/B experiment being validated,
receive an agreement message from one or more of said group of test execution engines agreeing to perform the test of the A/B experiment,
for each test execution engine agreeing to perform a test of the A/B experiment,
pass the A/B experiment data to the test execution engine via an interface component that is specific to the engine, and
receive via the interface component specific to the test execution engine, test results from the test of the A/B experiment, and
once test results are received from the identified test execution engine or engines, aggregate the test results to produce a validation indicator.
